(19) United States
(12) Patent Application Publication
(10) Pub. No.: US 2020/0118466 A1
(43) Pub. Date: Apr. 16, 2020

(54) SIMULATING EYE SURGERY

(71) Applicant: Bioniko Consulting, LLC, Sunny Isles, FL (US)

(72) Inventor: Andres BERNAL, Sunny Isles, FL (US)

(73) Assignee: Bioniko Consulting, LLC, Sunny Isles, FL (US)

(21) Appl. No.: 16/160,021

(22) Filed: Oct. 15, 2018

(51) Int. Cl. G09B 23/32; G09B 23/30

(52) U.S. Cl. CPC G09B 23/32; G09B 23/34; G09B 23/303

(57) ABSTRACT

An eye model enables simulation of surgical procedures involving both the anterior and posterior segments of the eye. The model includes a housing which supports attachment of an anterior segment. The anterior segment has a lens capsule that is movably suspended by a peripheral zonule. An anterior chamber is formed between a cornea and the lens capsule. A posterior segment with a posterior cavity is formed in the housing, and is fillable through a port formed in the housing. The posterior cavity is bounded anteriorly by the lens capsule, as in the eye. When the posterior cavity is filled with a vitreous fluid, fluid pressure causes movement of the lens capsule to change the shape of the anterior chamber. If an opening is formed through the lens capsule, vitreous can pass from the posterior cavity to the anterior chamber as the posterior cavity is pressurized through the port.

### FIELD OF THE DISCLOSURE

The disclosure relates to a system and method for simulating the eye, and in particular, to a physical model which can be used to simulate surgical procedures including prolapse of vitreous.

### BACKGROUND OF THE DISCLOSURE

Many surgical techniques requires dexterous movement and control by the surgeon. This dexterity cannot be developed by reading textbooks or watching instructional videos. Animal models or cadavers have been the default method for hands-on surgical training. In the field of ophthalmic surgery, there are simple examples of a cataract surgery model.

Eye models are fabricated using molding and casting, for example, and more recently using 3D printing technology which enables the creation of structures with discrete regions having customized mechanical properties. It is possible to print a single object that contains hard components or regions, soft components or regions, and components and regions with properties in-between. This is achieved by the simultaneous deposition of two complementary materials, one soft and one hard, in controlled proportions, in specific 3D coordinates.

### SUMMARY OF THE DISCLOSURE

In an embodiment of the disclosure, an eye model device includes structures resembling live eye components, and comprises a housing; an anterior segment positionable in attachment to the housing and including a lens capsule having an anterior capsule portion and a posterior capsule portion, the lens capsule movably suspended by a zonule formed as a flexible annular ring surrounding the lens capsule, and a cornea forming a transparent anterior dome, and an anterior chamber bounded by the lens capsule and the cornea; a posterior segment positioned in the housing and including a posterior cavity bounded by the housing and the posterior capsule portion of the lens capsule; the posterior cavity being fillable with a fluid and the anterior chamber being fillable by fluid, whereby when the posterior cavity is filled with a fluid and the anterior chamber is filled with a fluid, and there is formed a difference in pressure between the fluid in the posterior cavity and the fluid in the anterior chamber, the zonule will flex to enable a displacement of the lens capsule anteriorly or posteriorly.

In variations thereof, the device further includes: an eye socket portion attached to the housing forming a raised peripheral lip extending away from and above the anterior segment when the device is in use, the eye socket portion fillable with a liquid to at least partially submerge the anterior segment; a port extending between an exterior of the housing and an interior of the posterior cavity, the posterior cavity fillable by introducing fluid through the port, the pressure of the introduced fluid operable to cause movement of the lens capsule; a syringe hub in fluid communication with the port; a flexible iris, the iris movable when the lens capsule is moved by the introduced fluid; and/or a lens cortex within the lens capsule, the lens cortex bounded by the anterior capsule portion and the posterior capsule portion of the lens capsule.

In further variations thereof, the lens capsule does not include a lens cortex, and a circular opening is pre-made in the anterior capsule; and/or the lens capsule is reversibly attachable to the anterior segment by inserting the zonule within an annular internal peripheral groove in the anterior segment.

In yet further variations thereof, the device further includes: a suction cup connected to a side of the housing facing away from the anterior segment; a base having a lower portion and a flexible post attached to the lower portion, the housing attached to the flexible post to be movable with respect to base lower portion; the housing is removably attached to the flexible post; the anterior segment further includes an iris forming an open interior diameter, the iris including folds foldable to enable a change in the interior diameter; the iris forms a changed interior diameter when the lens capsule is moved due to a change in pressure in the posterior cavity relative to the anterior chamber; and/or the device further includes a base and an intermediate coupling, the intermediate coupling releasably attached to the housing and to the base, the intermediate coupling enabling the housing to be movable with respect to the base when the housing is attached to the intermediate coupling and the intermediate coupling is attached to the base.

In another embodiment of the disclosure, an eye model device includes structures resembling live eye components, comprising a housing including a peripheral internal groove; an anterior segment having a body including a peripheral internal groove, the anterior segment positionable in attachment to the housing and further including a resilient sclera portion insertable into the internal groove of the housing to form a seal with the housing; a lens capsule having an anterior capsule portion and a posterior capsule portion, the lens capsule movably suspended by a zonule formed as a flexible annular ring surrounding the lens capsule, the zonule insertable into the internal groove of the anterior segment, and a cornea forming a transparent dome, an anterior chamber bounded by the lens capsule and the cornea, the anterior chamber fillable with a fluid; a posterior segment positioned in the housing and including a posterior cavity bounded by the housing and the posterior capsule portion of the lens capsule, and a port extending between an exterior of the posterior segment and an interior of the posterior cavity; the posterior cavity fillable by introducing fluid through the port, the pressure of the introduced fluid operable to cause movement of the lens capsule.

In a further embodiment of the disclosure, a method of simulating a surgical procedure involving both the anterior and posterior segments of the eye, comprises: providing an eye model including structures resembling live eye components, the eye model including: an anterior segment positionable in attachment to the housing and including a lens capsule having an anterior capsule portion and a posterior capsule portion, the lens capsule movably suspended by a zonule, and a cornea, an anterior chamber bounded by the lens capsule and the cornea; a posterior segment positioned in the housing and including a posterior cavity bounded by the housing and the posterior capsule portion of the lens capsule, and a port extending between an exterior of the posterior segment and an interior of the posterior cavity.

In variations thereof, the method further includes attaching the anterior segment to the posterior segment by inserting a circumferential portion of one of the anterior segment and posterior segment into a circumferential groove of the other of the anterior segment and the posterior segment; the anterior segment and the posterior segment are joined to form a liquid tight seal by applying one of viscoelastic, petroleum jelly, adhesive, and gel between the anterior segment and the posterior segment; and/or the provided eye model further includes a port in fluid communication with the posterior cavity, the method further including changing a pressure in the posterior cavity by injecting or withdrawing fluid through the port.

In other variations thereof, the method further includes filling the posterior cavity with a fluid; filling the anterior chamber with a fluid; forming a difference in pressure between the fluid in the posterior cavity and the fluid in the anterior chamber by at least one of adding fluid to the posterior cavity or removing fluid from the posterior cavity, thereby causing the zonule to flex and displace the lens capsule anteriorly or posteriorly, respectively.

In still further variations thereof, the method further includes tearing material of the lens capsule to form an opening in at least one of the anterior capsule portion or the posterior capsule portion; and/or tearing of the material of the lens capsule completes a fluid communicating passageway from the posterior cavity to the anterior chamber, whereby fluid injected into the posterior cavity is flowable into the anterior chamber.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a perspective view of an eye surgery simulation device of the disclosure;

FIG. 2 is a top perspective view of the device of FIG. 1;

FIG. 3 is a cross-sectional side view through the center of the device of FIG. 1, having an eye socket area filled with a liquid;

FIG. 4 is a cross-sectional view of the device of FIG. 1;

FIG. 5 is an exploded cross-sectional view of the device of FIG. 1, with the anterior segment removed;

FIG. 6 is a top plan view of an anterior segment portion of the device of FIG. 1;

FIG. 7 is a cross-section bifurcation of the anterior segment of FIG. 6;

FIG. 8 is an exploded view of the device of FIG. 6, showing alternative lens capsules;

FIG. 9 is a perspective view of the anterior segment of FIG. 6, showing an expandable iris structure;

FIG. 10 is cross-sectional bifurcation of an anterior segment of the disclosure, showing both ripple dimensions of the iris;

FIG. 11 is diagrammatic cross-sectional view of a device of the disclosure illustrating a neutral pressure between anterior and posterior segments;

FIG. 12 depicts the device of FIG. 11 with a relatively higher pressure in the posterior segment;

FIG. 13 depicts the device of FIG. 11 with a relatively higher pressure in the anterior segment; and

FIG. 14 depicts vitreous prolapse simulated in a device of the disclosure.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

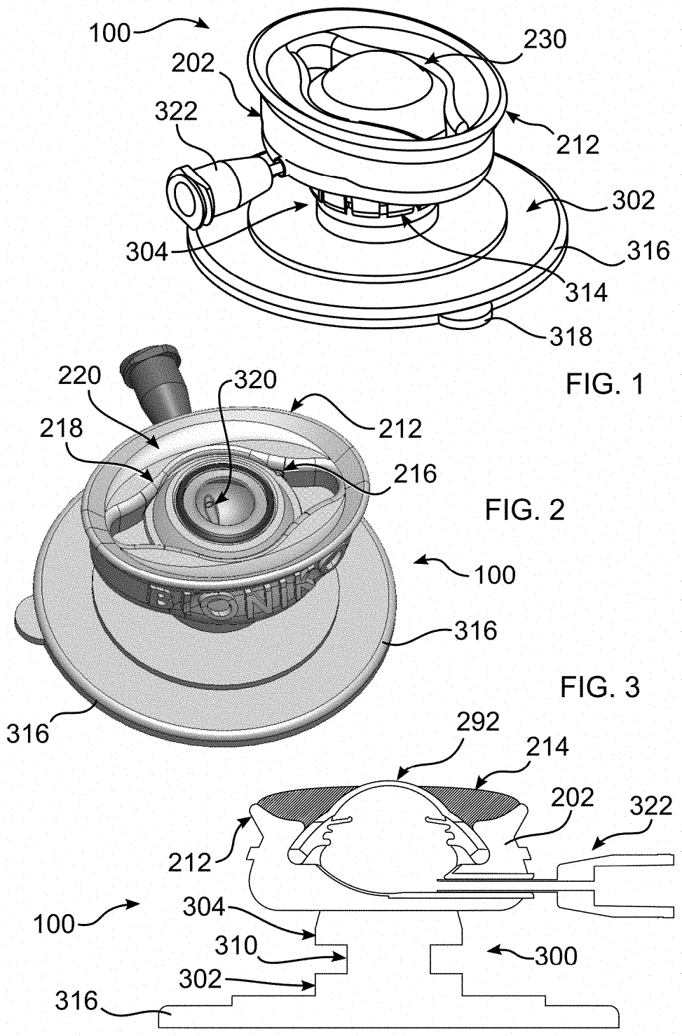

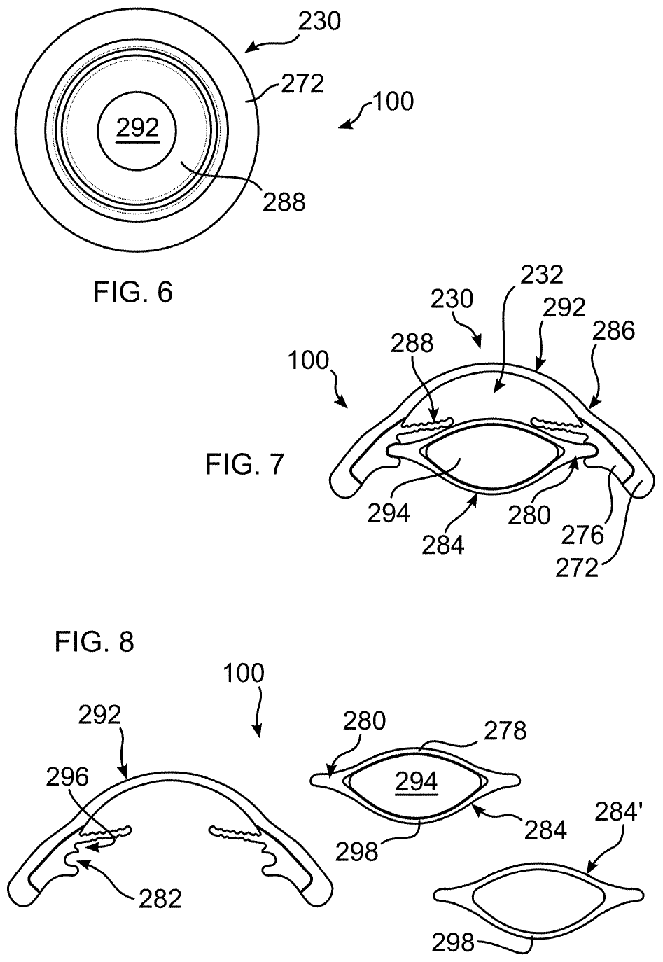

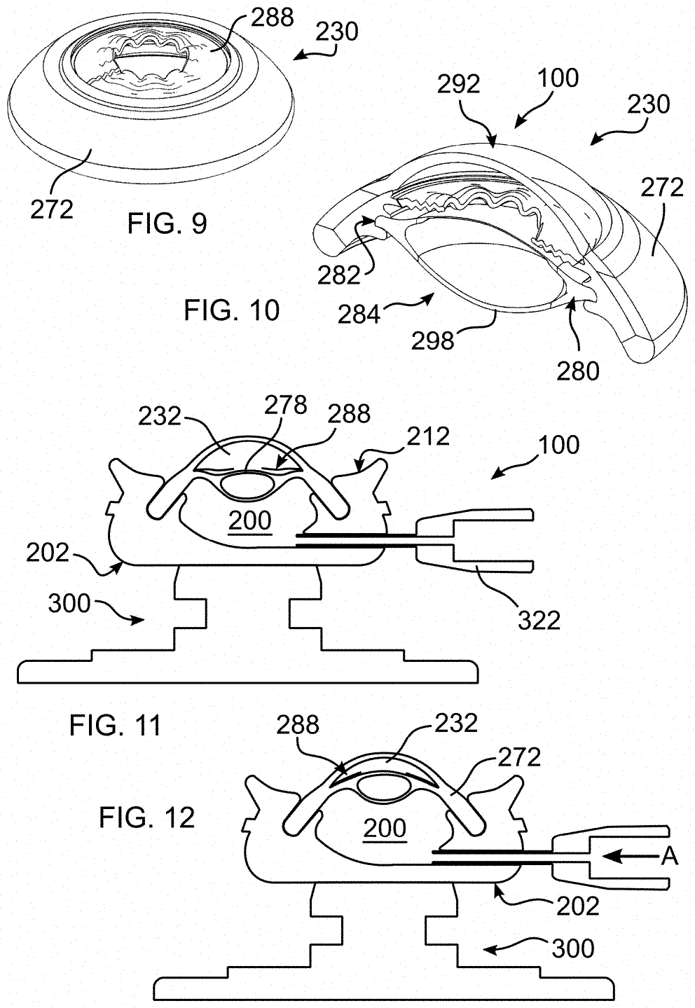

With reference to FIGS. 1-6, an eye model device 100 of the disclosure enables simulation and control of a pressure differential between the posterior cavity/posterior segment 200 (formed within housing 202), which forms a vitreous containing cavity which can hold simulated vitreous, such as egg white, gel, fluid, or air, and the anterior segment 230, which can contain simulated aqueous humor (a clear, watery fluid), such as a gel, fluid, or air. In the human eye, the pressure in between anterior and posterior segments is naturally balanced in order to establish and maintain a proper eye shape and function. In addition to enabling simulation of capsulorhexis and phacoemulsification, for example, device 100 enables a simulation of a change in this balance, as it occurs in intra-ocular surgery, including its related complications, such as intrusion of vitreous into the anterior segment, as well as other surgical scenarios described herein. It would be helpful for surgeons to be able to practice these scenarios before encountering them in the operating room (OR).

Device 100 includes a base 300 which can have a variety of forms, and in accordance with the disclosure, secures eye components within housing 202 to a working surface, while enabling movement of the eye components as would occur during surgery of the eye of a patient. The function and purpose of an eye model base has been additionally discussed in U.S. Patent Publication 2016/0063898 of the instant Applicant, which is incorporated by reference herein, and which includes the examples of socket housing 14 and base 52 therein. In the instant embodiment, and particularly with reference to FIG. 5, base 300 includes a lower base portion 302, and an intermediate coupling 304. A peripheral flange 306 of intermediate coupling 304 is inserted within a housing channel 206 to retain intermediate coupling 304 in engagement with housing 202. At least one of channel 206 and flange 306 is resilient, to enable sufficient relative distortion for mutual coupling.

The foregoing illustrates one possible way to mount housing 202 and other eye components as described herein in order to enable realistic eye movement during surgery. In another embodiment, suction cup 316 is directly coupled to housing 202. Alternatively, a flexible member can be interposed between suction cup 316 and housing 202.

A series of spaced housing projections 208 matingly engage intermediate coupling apertures 308 of intermediate coupling 304, to limit relative rotation between intermediate coupling 304 and housing 202. Alternatively, as elsewhere herein, a mating aperture/channel and projection/flange can be swapped on the respective mating parts, without departing from the described purpose. The materials and methods described in the incorporated references can be applied to producing device 100 described herein.

Base lower base portion 302 includes a mounting post 310 having a circumferential channel 312. Intermediate coupling 304 includes circumferential extensions 314 disposed to surround post 310 when coupling 304 is mounted upon lower base portion 302. Inwardly projecting flanges 324 engage channel 312 to secure intermediate coupling 304 to lower base portion 302, and to thereby secure lower base portion 302 to housing 202. At least one of extensions 314 and post 310 is resilient, to enable mutual coupling. In an embodiment, all three of housing 202, intermediate coupling 304, and suction cup portion are made with a resilient material, such as a polymer.

Post 310 and/or a coupling formed between post 310 and intermediate coupling 304 is sufficiently flexible to enable housing 202 to flex in all directions, in a manner akin to an eye during surgery. Lower base portion 302 forms a suction cup 316 at a lowermost portion, either integrally with portion 302, as illustrated, or as a separate component attached to base portion 302. As can be seen in FIG. 1, a release tab 318 can be provided to allow air under suction cup 316 when tab 318 is lifted from a surface upon which suction cup 316 is vacuum adhered.

A fluid introduction port 320 is provided, through which a hub and needle 322 can be inserted. In an embodiment, hub and needle 322 includes a Luer lock or other convenient coupling, to enable ready attachment to a syringe barrel, for example a standard 5 cc syringe. Port 320 enables the introduction and withdrawal of a fluid, and particularly a vitreous substitute such as egg whites, into the posterior segment 200 of the eye model.

In addition to forming a posterior segment 200, housing 202 forms an insertion channel 204 for attaching a separable anterior segment 230. Insertion channel 204 forms an inner fold of an eyelid 218, which extends to form a peripheral eye socket 220.

Housing 202 includes a circumferential seal 210 which mates with a mating circumferential ring shaped sclera 272 portion of a separable anterior segment model 230, described further elsewhere herein. Seal 210 and/or sclera 272 are sufficiently flexible so that either or both may be distorted to enable insertion of sclera 272 into seal 210, to make a flexible and liquid tight seal between an exterior of the eye and the posterior cavity containing vitreous. The lens structure 284 separates the posterior and anterior segments 200, 230, and includes the anterior and posterior lens capsule 278, 298, the lens cortex/nucleus 294, and the zonule 280.

A raised peripheral lip 212 forms a reservoir for a supply of liquid, enabling submersion of an assembled anterior segment, at least to a height above a typical area of incision 326

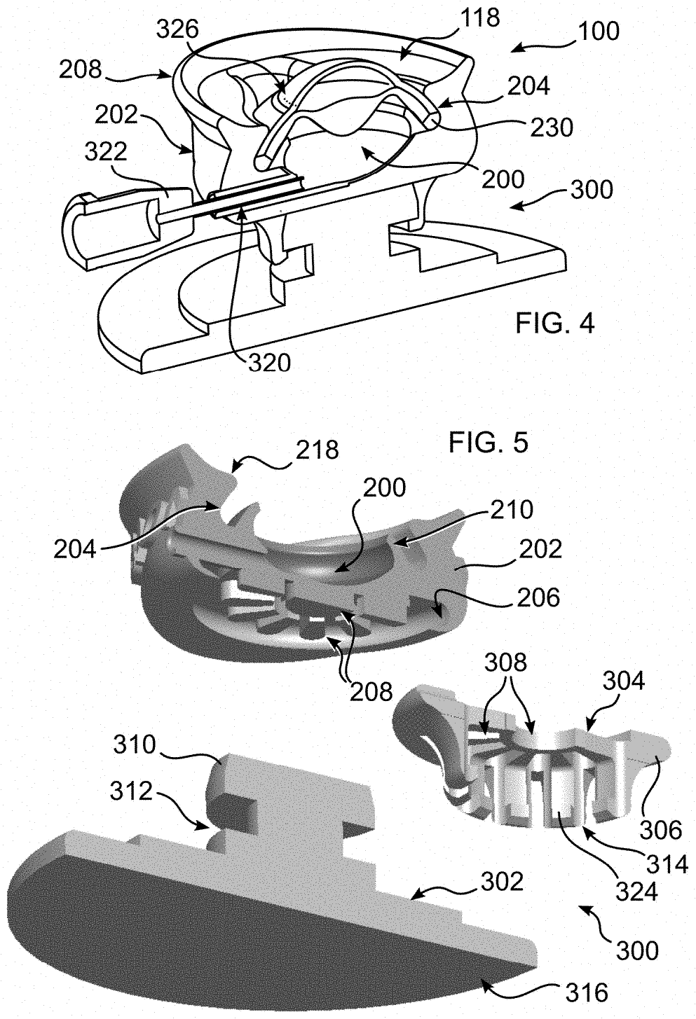

(FIG. 4) and insertion of instruments. In this manner, ingress of bubbles into the eye can be mitigated, particularly when using instruments with high rates of aspiration during phacoemulsification of a lens cortex, or during vitrectomy. FIG. 3 depicts housing 202 filled with a liquid, for example water, where meniscus 214 covers all but the anterior-most portion of the cornea 292. In this manner, an opening in the eye below the meniscus is less likely to admit air into the anterior chamber, which can affect visibility of the working site for the surgeon. Peripheral lip 212 can be oval shaped like the eye socket, as illustrated, to improve the realistic appearance of the eye model, or can have another shape. Peripheral lip 212 can be sufficiently tall to enable covering of the complete anterior portion of the eye, or can be shallower than illustrated.

As can be seen in FIG. 2, a 0.6 mm tear duct or punctum 216 can be seen, provided at least to improve the realistic appearance of the model. In an embodiment, the fluid retained by peripheral lip 212 is supplied through punctum 216, which is provided with a port on another surface of the eye model that is similar in design and function to port 320. However, as a practical matter, irrigation surgery instruments normally provide fluids which can be used to fill the peripheral lip 212, or which can actively introduce fluid within the eye which can emerge from the incision to then fill peripheral lip 212. Filling of the peripheral lip 212 can be actively carried out prior to simulating a procedure, or peripheral lip 212 can be used to passively collect fluid which emerges during a procedure within the eye.

Anterior segment model portions are described in the Applicant's U.S. Pat. No. 9,437,119 and U.S. Patent Publications 2016/0372011 and 2016/0063898, all of which are incorporated herein by reference. In accordance with the instant disclosure, anterior segment is formed with resilient materials, and can include one or more representations of the following biological eye structures of the anterior eye anatomy: sclera 272, conjunctiva, limbus 286, cornea 292, lens cortex/nucleus 294, anterior and posterior lens capsule 278, 298, zonule 280, ciliary body 276, Schlemm's canal, trabecular meshwork, iris 288, ciliary sulcus 296, and/or anterior hyaloid membrane, supra-choroidal space, as well as any other anterior segment structure. Additional features to simulate abnormalities of the eye for purposes of the medical procedure can also be introduced.

In an embodiment, iris 288 can be provided with a geometrical design which allows it to behave more realistically, for example including folds 290 (FIG. 10) that allow additional stretch and looseness to the iris beyond of that provided by the elastic properties of the material alone. In one embodiment, iris 288 has a bi-axial wave pattern to create a life-like laxity, which includes a wave pattern which is radial and which extends from the exterior of the iris to the center, creating circular crests and valleys concentric to the optical axis. The ripples enable additional stretch and laxity in the radial direction. Additionally, a second overlapping wave pattern can be provided which is circular, extending about the iris circumference, creating radial crests and valleys which enable additional stretch and laxity in the transverse direction, circular and perpendicular to a radial vector. The waves can vary in amplitude and period to create the effect desired. They waves can also have decay properties, so that the wave has a larger amplitude in the pupil than on the limbus edge. In this manner, the iris can open as expected when pressure in the posterior segment is increased and the anterior chamber shallows.

Cornea 292 can be fabricated with a flexible and transparent polymer, and forms a transparent dome over the anterior segment, as in the natural eye. Sclera 272 can be formed with an opaque and flexible polymer and extend, for example, up to 8 mm behind the limbus 286 to form an insertion flange for the anterior segment. Ciliary body 276 can include a 360 degree groove around the optical axis to receive a mating zonule 280 of a lens structure 284. Anterior lens capsule 278 is a membrane that can be composed of a flexible material that can be torn manually or by laser energy, as would be expected for a living eye. Lens cortex 294 is formed with a material that can be removed by mechanical emulsification and aspiration, in a manner as would be expected for a living eye. Zonule 280 can be rigid or partially rigid, and extends circumferentially to form an annular ring and a ridge that mates with peripheral groove 282 of the ciliary body of anterior segment 230. Herein, where a peripheral or circumferential extending portion of one part is inserted into a peripheral or circumferential groove of a mating part, it should be understood that the extending portion and groove portion could be swapped among the two parts.

As described herein, and as would be evident to a practitioner, device 100 provides for emulating and practicing a variety of surgical procedures, including but not limited to procedures accompanying cataract surgery, for example capsulorhexis, phacoemulsification, femto-second laser capsulotomy and lens fragmentation. Cataract complications, such as anterior vitrectomy, can be practiced via the cornea or pars-plana. Surgical procedures to the iris can be practiced, including expansion, suturing, pupiloplasty, and IOL (Intraocular lens)-suturing. Other procedures without the lens (aphakic) can be practiced, including inserting an IOL in the sulcus, IOL gluing techniques to the sclera, and insertion of intraocular devices such as tension rings. Insertion of glaucoma devices in the angle or supra-choroidal space such as micro-stents can also be simulated.

Components of device 100 can be made of the same or different materials. The components can be formed using any known or hereinafter developed method, including molding, stamping, die cutting, extruding, stitching, press fitting, and 3D printing, the later using multiple materials during printing, for example.

As can be seen in FIG. 8, the lens structure 284 is separable from a remainder of the anterior segment, so that the lens structure can be changed during a simulated surgical procedure, and then replaced as needed. The zonule 280 portions at the ends of the lens structure fit within a peripheral groove 282 at an anatomical location of the ciliary body. Water or other lubricant can be applied if needed to groove 282 to ease insertion. In FIG. 8, two lens structures 284, 284′ are shown, in which lens structure 284′ does not contain a lens cortex 294. The absence of a lens cortex 294 can be useful when it is desired to simulate remediation of a PCR (Posterior Capsular Rupture), for example, as shown in FIG. 14.

More particularly, when a hole is formed in the posterior lens capsule 298, for example as a result of trauma or a complication of a surgical procedure, vitreous 222 may prolapse (flow) into the anterior chamber 232. This is shown in FIG. 14, in which vitreous 222 (depicted as hatched material in FIG. 14) has emerged through the PCR, and is advancing towards the capsulorhexis 224. Flow into the anterior segment is caused by a relatively higher fluid pressure in the posterior segment, and particularly the posterior cavity which contains the vitreous. The pressure differential is exacerbated as the anterior segment is often punctured during trauma or during a surgical procedure, and thus has a lower than natural pressure.

The intrusion of vitreous in the anterior segment poses significant problems during surgery, as the vitreous must be removed from the anterior segment without teasing or pulling more vitreous from the posterior segment, which can result in retinal detachment and other problems. Additionally, vitreous must be completely removed from the anterior chamber if normal eye function is to be restored.

In one surgical procedure to address this problem, a viscoelastic material is injected into the anterior segment to slow or stop the intrusion of vitreous, and the vitreous that has intruded is cut with a high speed cutter. Visibility of the vitreous can be improved with the injection of various dies into the anterior segment. If possible, the posterior lens capsule is reconstituted by creating a posterior capsulorhexis manoeuver. an intraocular lens (IOL) can then be implanted in the sulcus, sutured to the sclera, or sutured to the iris, or within the capsule, if the latter remains stable. As described further elsewhere herein, device 100 can be used to model vitreous prolapse during a surgical procedure.

The foregoing discussion highlights one manifestation of a pressure differential between the anterior and posterior segments. However, other manifestations can occur during surgery which can be simulated using device 100. More particularly, a pressure differential between the anterior and posterior segments can cause displacement of the lens structure and iris anteriorly if the pressure in the posterior segment/posterior cavity is relatively greater, or posteriorly if the pressure in the posterior cavity is relatively lower. Device 100 can be used to simulate this occurrence, as well, by manipulating pressure in either segment independently or simultaneously.

For example, when a surgeon makes an incision in the cornea and permits aqueous fluid to escape from the anterior segment, there will be a pressure loss in the anterior segment. The resultant pressure differential with the vitreous will push the lens anteriorly causing the anterior chamber to become more shallow (smaller). If the surgeon then injects sufficient fluid through this or another incision, the pressure differential can be countered, and even reversed, causing the anterior chamber to deepen (enlarge), providing more working space within the anterior chamber for a remainder of the surgical procedure. Typically, surgeons inject a viscoelastic substance in the form of a gel for this purpose. These gels are termed OVDs (Opthalmic Viscosurgical Device), and are typically a sodium hyaluronate, which is naturally occurring in the eye.

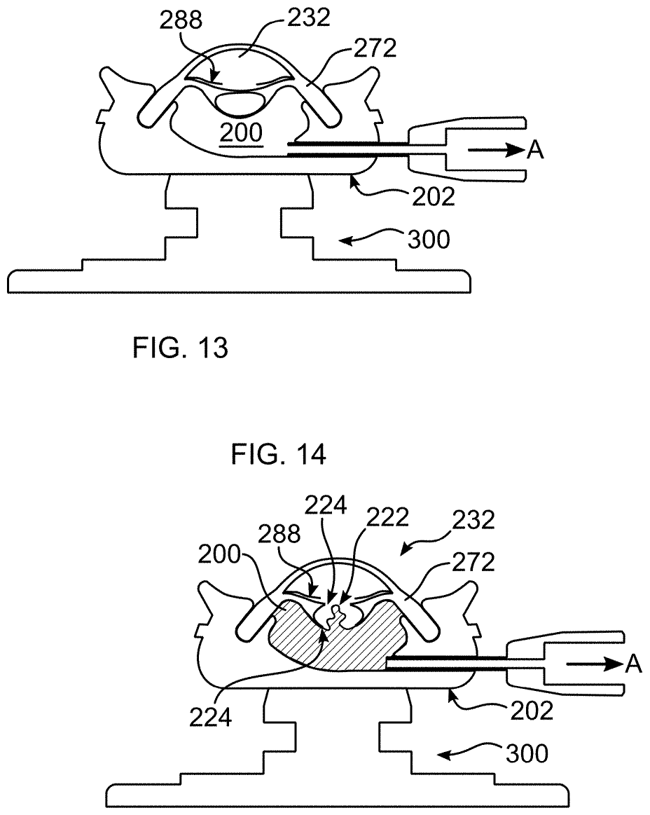

Device 100 enables a simulation of this effect, as shown in FIGS. 11-13, in which FIG. 11 represents the eye in balance, the pressure in the anterior chamber 232 equaling the pressure in the posterior segment/posterior cavity 200. In FIG. 12, fluid (e.g. vitreous substitute) has been introduced into the posterior cavity under pressure, causing an increase in pressure in the posterior cavity which exceeds the pressure in the anterior chamber, thereby causing a displacement of the lens structure and a shrinking of the size of the anterior chamber 232. Conversely, in FIG. 13, fluid is withdrawn from the posterior cavity, causing a reduction in the pressure in the posterior cavity to a level below that of the anterior chamber, resulting in an increase in the size of the anterior chamber.

During the cataract surgery itself surgeons use vacuum to extract the lens contents; if the vacuum is not properly compensated by irrigation, this creates a pressure differential that can pull the posterior lens capsule anteriorly and cause the surgeon to tear it with the instruments, causing the aforedescribed PCR. The disclosure provides a system for experiencing these pressure manifestations and learning to address them quickly and properly. More particularly, device 100 enables the introduction or withdrawal of fluid from the posterior segment, using a syringe or pump connected to port 320, to alter the pressure in the posterior segment, and thereby affect the anterior segment, as further described elsewhere herein, during simulation of a surgical procedure.

Device 100 is prepared for simulating eye surgery, in one embodiment, as follows. Base 300 is positioned upon a smooth surface and is pressed downwards against the surface to engage suction cup 316. If an anterior vitrectomy is to be performed, a syringe filled with a vitreous substitute (e.g. egg whites) is connected to port 320. Dispersive viscoelastic is distributed about circumferential seal 210, and the vitreous is slowly injected up to the level of the seal 210. Next, the sclera 272 of an anterior segment 230 is gently inserted under the eyelid 218 and into seal 210, and is not disturbed for 5 minutes while the viscoelastic sets/dries between the seal and sclera, creating a temporary bond for a tighter seal. Glue, petroleum jelly, silicone, caulking, etc can be also added to achieve the desired effect with different degrees of permanency.

In one embodiment, vitreous loss can be simulated either (a) after partially or completely removing the lens cortex, for example in a phaco procedure, or (b) if using an empty lens structure 284′. For step (b), a pre-made rhexis should be prepared. To carry out the former, an anterior segment 230 including a lens with a lens capsule, surrounding a lens cortex 294, is inserted into the anterior segment as described elsewhere herein. The anterior lens capsule is torn and the cortex is then removed in accordance with known techniques, or as described in the incorporated references, which can include excising or emulsifying the lens cortex, for example. A main incision and paracentesis can be formed in the cornea. Such locations can be marked with ink or a dye for ease of location during subsequent uses of device 100.

Once the lens cortex has been removed, or once there is otherwise an empty lens structure or the posterior lens capsule is exposed, a PCR is created using an energized phaco hand-piece, or with a second instrument. In an embodiment, the rupture is at least 3-4 mm large, so that vitreous can readily flow anteriorly. If using an empty lens structure 284′, the PCR can be formed prior to assembling the lens structure into the anterior segment 230. An anterior rhexis can be preformed or pre-fabricated in lens structure 284′, but if not provided, such opening can be performed before or after insertion of the lens structure.

Once device 100 has been prepared with an empty lens structure, the vitreous can be slowly injected, after which it will flow through the PCR and into the anterior chamber. For simulation of certain surgical procedures, it is important to create at least one incision before injecting vitreous so that air in the anterior chamber can escape. Failing to do so could prevent or impair intrusion of vitreous into the anterior chamber, and if sufficient pressure is created, vitreous could overcome seal 210 and escape at that location. Once sufficient vitreous has entered the anterior chamber, proceed to perform an anterior vitrectomy using a selected or experimental technique. If helpful, any air that has entered anterior chamber 232 can be removed after vitreous injection and prior to beginning the procedure. Typically, the viscoelastic is removed by using vacuum, accompanied by the introduction of a fluid to maintain a desired pressure range within the anterior chamber, which can also be simulated using device 100. Once a procedure is complete, more vitreous can be injected to begin a new procedure.

Where vitreous is to be injected, and particularly after multiple uses, it may be helpful to maintain pressure on the anterior segment, to help maintain the seal at 210, and to ensure vitreous prolapses into the anterior chamber. In addition, a dye or contrast enhancer, such as triamcinolone can be added to facilitate visualization of the vitreous substitute.

Anterior segment 230 can be removed by leveraging it against socket 220 with a blunt object near either eye corner, after which suction tab 318 can be lifted to remove device 100 from the smooth surface.

The components of the systems and apparatuses may be integrated or separated. Moreover. The systems and apparatuses disclosed herein may be performed by more, fewer, or other components, and methods may include more, fewer, or other steps. Applicants do not intend any of the claims to invoke 35 U.S.C. 112(f) unless the words “means for” or “step for” are explicitly used in the particular claim.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

References in the Figures:

| | |
|---|---|
| 100 | eye model device |
| 200 | posterior segment/posterior |
| | cavity |
| 202 | housing |
| 204 | insertion channel |
| 206 | housing channel |
| 208 | housing projections |
| 210 | circumferential seal |
| 212 | peripheral lip |
| 214 | peripheral lip meniscus |
| 216 | punctum |
| 218 | eyelid |
| 220 | eye socket |
| 222 | vitreous |
| 224 | capsulorhexis |
| 226 | posterior capsular rupture |
| 230 | anterior segment |
| 232 | anterior chamber |
| 272 | sclera |
| 276 | ciliary body |
| 278 | anterior lens capsule |
| 280 | zonule |
| 282 | peripheral groove |
| 284 | lens structure |
| 284′ | lens structure w/o cortex |
| 286 | limbus |
| 288 | iris |
| 290 | iris folds |
| 292 | cornea |
| 294 | lens cortex/nucleus |
| 296 | ciliary sulcus |
| 298 | posterior lens capsule |
| 300 | base |
| 302 | lower base portion |
| 304 | intermediate coupling |
| 306 | base peripheral flange |
| 308 | intermediate coupling apertures |
| 310 | mounting post |
| 312 | lower base channel |
| 314 | coupling extensions |
| 316 | suction cup |
| 318 | suction cup release tab |
| 320 | fluid introduction port |
| 322 | hub and needle |
| 324 | inward flanges |

What is claimed is:

1. An eye model device including structures resembling live eye components, comprising:
a housing;
an anterior segment positionable in attachment to the housing and including
a lens capsule having an anterior capsule portion and a posterior capsule portion, the lens capsule movably suspended by a zonule formed as a flexible annular ring surrounding the lens capsule, and
a cornea forming a transparent anterior dome, and
an anterior chamber bounded by the lens capsule and the cornea;
a posterior segment positioned in the housing and including a posterior cavity bounded by the housing and the posterior capsule portion of the lens capsule;
the posterior cavity being fillable with a fluid and the anterior chamber being fillable by fluid, whereby when the posterior cavity is filled with a fluid and the anterior chamber is filled with a fluid, and there is formed a difference in pressure between the fluid in the posterior cavity and the fluid in the anterior chamber, the zonule will flex to enable a displacement of the lens capsule anteriorly or posteriorly.

2. The device of claim 1, further including an eye socket portion attached to the housing forming a raised peripheral lip extending away from and above the anterior segment when the device is in use, the eye socket portion fillable with a liquid to at least partially submerge the anterior segment.

3. The device of claim 1, further including a port extending between an exterior of the housing and an interior of the posterior cavity, the posterior cavity fillable by introducing fluid through the port, the pressure of the introduced fluid operable to cause movement of the lens capsule.

4. The device of claim 3, further including a syringe hub in fluid communication with the port.

5. The device of claim 1, further including a flexible iris, the iris movable when the lens capsule is moved by the introduced fluid.

6. The device of claim 1, further including a lens cortex within the lens capsule, the lens cortex bounded by the anterior capsule portion and the posterior capsule portion of the lens capsule.

7. The device of claim 1, wherein the lens capsule does not include a lens cortex, and a circular opening is pre-made in the anterior capsule.

8. The device of claim 1, wherein the lens capsule is reversibly attachable to the anterior segment by inserting the zonule within an annular internal peripheral groove in the anterior segment.

9. The device of claim 1, further including a suction cup connected to a side of the housing facing away from the anterior segment.

10. The device of claim 1, further including a base having a lower portion and a flexible post attached to the lower portion, the housing attached to the flexible post to be movable with respect to base lower portion.

11. The device of claim 10, the housing removably attached to the flexible post.

12. The device of claim 1, the anterior segment further including an iris forming an open interior diameter, the iris including folds foldable to enable a change in the interior diameter.

13. The device of claim 12, the iris forming a changed interior diameter when the lens capsule is moved due to a change in pressure in the posterior cavity relative to the anterior chamber.

14. The device of claim 1, further including a base and an intermediate coupling, the intermediate coupling releasably attached to the housing and to the base, the intermediate coupling enabling the housing to be movable with respect to the base when the housing is attached to the intermediate coupling and the intermediate coupling is attached to the base.

15. An eye model device including structures resembling live eye components, comprising:
a housing including a peripheral internal groove;
an anterior segment having a body including a peripheral internal groove, the anterior segment positionable in attachment to the housing and further including
a resilient sclera portion insertable into the internal groove of the housing to form a seal with the housing;
a lens capsule having an anterior capsule portion and a posterior capsule portion, the lens capsule movably suspended by a zonule formed as a flexible annular ring surrounding the lens capsule, the zonule insertable into the internal groove of the anterior segment, and
a cornea forming a transparent dome,
an anterior chamber bounded by the lens capsule and the cornea, the anterior chamber fillable with a fluid;
a posterior segment positioned in the housing and including
a posterior cavity bounded by the housing and the posterior capsule portion of the lens capsule, and
a port extending between an exterior of the posterior segment and an interior of the posterior cavity;
the posterior cavity fillable by introducing fluid through the port, the pressure of the introduced fluid operable to cause movement of the lens capsule.

16. A method of simulating a surgical procedure involving both the anterior and posterior segments of the eye, comprising:
providing an eye model including structures resembling live eye components, the eye model including:
an anterior segment positionable in attachment to the housing and including
a lens capsule having an anterior capsule portion and a posterior capsule portion, the lens capsule movably suspended by a zonule, and
a cornea,
an anterior chamber bounded by the lens capsule and the cornea;
a posterior segment positioned in the housing and including
a posterior cavity bounded by the housing and the posterior capsule portion of the lens capsule, and
a port extending between an exterior of the posterior segment and an interior of the posterior cavity.

17. The method of claim 16, further including attaching the anterior segment to the posterior segment by inserting a circumferential portion of one of the anterior segment and posterior segment into a circumferential groove of the other of the anterior segment and the posterior segment.

18. The method of claim 16, wherein the anterior segment and the posterior segment are joined to form a liquid tight seal by applying one of viscoelastic, petroleum jelly, adhesive, and gel between the anterior segment and the posterior segment.

19. The method of claim 16, the provided eye model further including a port in fluid communication with the posterior cavity, the method further including changing a pressure in the posterior cavity by injecting or withdrawing fluid through the port.

20. The method of claim 16, further including:
filling the posterior cavity with a fluid;
filling the anterior chamber with a fluid;
forming a difference in pressure between the fluid in the posterior cavity and the fluid in the anterior chamber by at least one of adding fluid to the posterior cavity or removing fluid from the posterior cavity, thereby causing the zonule to flex and displace the lens capsule anteriorly or posteriorly, respectively.

21. The method of claim 16, further including tearing material of the lens capsule to form an opening in at least one of the anterior capsule portion or the posterior capsule portion.

22. The method of claim 21, wherein tearing of the material of the lens capsule completes a fluid communicating passageway from the posterior cavity to the anterior chamber, whereby fluid injected into the posterior cavity is flowable into the anterior chamber.
